(19) United States
(12) Patent Application Publication
(10) Pub. No.: US 2013/0196733 A1
(43) Pub. Date: Aug. 1, 2013

(54) Systems and Methods for Integrated Game Play Through the Use of Proximity-Based Communication on Smart Phones and Hand Held Devices

(71) Applicant: LINQ3 TECHNOLOGIES LLC, New York, NY (US)

(72) Inventors: Daniel CAGE, New York, NY (US); David Tashjian, New York, NY (US); Roy LEACH, Elizabeth, CO (US)

(73) Assignee: LINQ3 TECHNOLOGIES LLC, New York, NY (US)

(21) Appl. No.: 13/757,512

(22) Filed: Feb. 1, 2013

Related U.S. Application Data
(60) Provisional application No. 61/593,762, filed on Feb. 1, 2012.

(51) Int. Cl. G07F 17/32

(52) U.S. Cl. CPC G07F 17/3225
USPC 463/17

(57) ABSTRACT

A user device in a system for selling gaming products receives a game play request from a user. The user device detects being tapped to an external proximity-based communication enabled device using a communication interface that communicates over a proximity-based communication connection. Upon detecting that the user device has been tapped to the external proximity-based communication enabled device, the user device sends a gaming request associated with the game play request over a wireless network. The proximity-based communication protocols ensure that the gaming transaction occurs in a geographical location that is within the jurisdiction of the appropriate gaming authority.

### CROSS REFERENCE TO RELATED APPLICATIONS

This application claims priority to U.S. Provisional App. Ser. No. 61/593,762, filed Feb. 1, 2012, which is incorporated by reference in its entirety.

### TECHNICAL FIELD

This disclosure generally relates to game play systems for the sale of, for example, sponsored lottery products, and, more specifically, this disclosure relates to providing integrated game play and sale of lottery products on, for example, handheld devices and smart phones using proximity-based communication technology.

### BACKGROUND

Many governments have passed laws permitting lottery games to be legalized within their borders. These laws are due to the public support for this style of entertainment. Currently, these games are presented through specific manned terminals that connect to lottery operators—corporations responsible for running the lottery games. While these games have proven to be popular, a large segment of the population does not participate. This is due to many factors including a lack of desire to interact with personnel running the game kiosks, the inconvenience of the manned terminals, the concern over losing a ticket, and, more recently, the lack of cash to play the games as many people are only using payment cards for purchases.

In addition, due to regulatory restrictions, the sale of lottery products is restricted to be within the borders of the government regulating the lottery games. Therefore, existing sales solutions used on mobile devices such as handheld devices and smart phones are not appropriate for the sale of the lottery games because they lack assurances that the mobile device is located within the borders of the government regulating the lottery game.

### SUMMARY

According to one embodiment, a device for selling gaming products may comprise a first communication interface that communicates over a Near Field Communication (NFC) connection; a second communication interface that communicates over a wireless network; and a processor configured to receive a game play request from a user, detect, using the first communication interface, the device being tapped to an external NFC enabled device, and upon detecting that the device has been tapped to the external NFC enabled device, send a gaming request associated with the game play request over the second communication interface.

According to another embodiment, a device for facilitating the sale of gaming products may comprise a first communication interface that communicates with a user device over a network; a second communication interface that communicates with a gaming authority over a second network; and a processor configured to receive a game play request from the user device over the first communication interface, and verify a location of the user device.

According to another embodiment, a method for selling gaming product may comprise receiving, by a user device, a game play request from a user; bringing the user device in proximity to a proximity-based communication enabled device;

sending a gaming request associated with the game play request to a gaming facilitator; sending information identifying the proximity-based communication enabled device to the gaming facilitator; verifying a location of the user device; obtaining payment authorization associated with the game play request; sending a ticketing request corresponding with the gaming request to a gaming authority; and sending a result of game play associated with the ticketing request to the user device.

According to another embodiment, a non-transitory computer readable medium may be encoded thereon with a program that when executed by a processor of a user device, causes the processor to perform a method that may comprise receiving a game play request from a user, detecting, using a Near Field Communication (NFC) interface, the user device being tapped to an external NFC enabled device, and sending, upon detecting that the user device has been tapped to the external NFC enabled device, a gaming request associated with the game play request over a wireless network to a gaming facilitator.

These and other advantages of the present disclosure will become apparent to those skilled in the art from the following detailed description, the accompanying drawings, and the appended claims.

### BRIEF DESCRIPTION OF THE DRAWINGS

FIGS. 1A and 1B are schematic diagrams illustrating a game play system.

FIG. 2A is a schematic diagram illustrating a communications exchange server.

FIG. 2B is a schematic diagram illustrating a communications exchange server.

FIG. 3 is a flow diagram illustrating a process for a game play.

FIGS. 4A and 4B are flow diagrams illustrating methods for verifying the location of a mobile device.

FIG. 5 is a schematic diagram illustrating a process for a game play.

FIGS. 6A, 6B and 6C are schematic diagrams illustrating input systems.

FIGS. 7A, 7B, and 7C are flow diagrams illustrating processes for a mobile application-based play of a lottery system presented game.

FIGS. 8A, 8B, and 8C are flow diagrams illustrating processes for a host-based play and mobile application-based play where the mobile application has a substantially constant connection of an automated lottery system presented game.

FIG. 9 is a schematic diagram illustrating a gaming facilitator system.

### DETAILED DESCRIPTION

The disclosed systems and methods make lottery games accessible to a larger segment of the population by providing an end-to-end lottery solution for integrated game play and sale of lottery products on, for example, hand held devices and smart phones using proximity-based communication technology, such as NFC technology, audio-frequency communication or audio signature technologies, and the like. A player operates an application on a mobile device, which may be provided for download or supplied with the device, that allows them to select lottery games and ticketing options. In some embodiments, the selection can be made at any time and location. The selections are recorded, for example in a virtual shopping cart, by the lottery application on the mobile device. The player purchases these recorded items at proximity-based communication enabled locations that are, for example, pre-approved by a gaming facilitator and/or a gaming authority. Redemption of winning plays can be automatically deposited into an account associated with the player or at a retail location by use of, for example, a barcode sent to the mobile device.

The use of proximity-based communication technology with an application distributed to mobile devices allows for the following exemplary advantages:
Issuing and managing a trusted execution environment.
Assigning trusted area within a trusted execution environment to a specific service.
Managing keys for a trusted execution environment.
Securely downloading lottery applications to proximity-based communication enabled mobile phones.
Personalizing applications.
Locking, unlocking and deleting the lottery application according to requests from a user or service provider.
Providing secure logging and accounting settlement of all lottery transactions.
Utilizing the security of proximity-based communication readers and gate entry devices to connect the user from their mobile network operator (a network operator providing voice and/or data services to handset users, which may use its own physical network or may use other network facilities operating as a mobile virtual network operator) to the lottery authority and gaming system.

The gaming facilitator enables secure data storage of lottery transactions at the device level using, for example, a Universal Integrated Circuit Card (UICC) through processing and transaction confirmation.

The UICC is a physically secure device, an integrated circuit (IC) card, or smart card, that can be inserted and removed from terminal equipment. The UICC may contain one or more applications and may be referred to using different terminology in different territories. A Subscriber Identity Module (SIM) is an application on the UICC containing a mobile subscriber's unique identity.

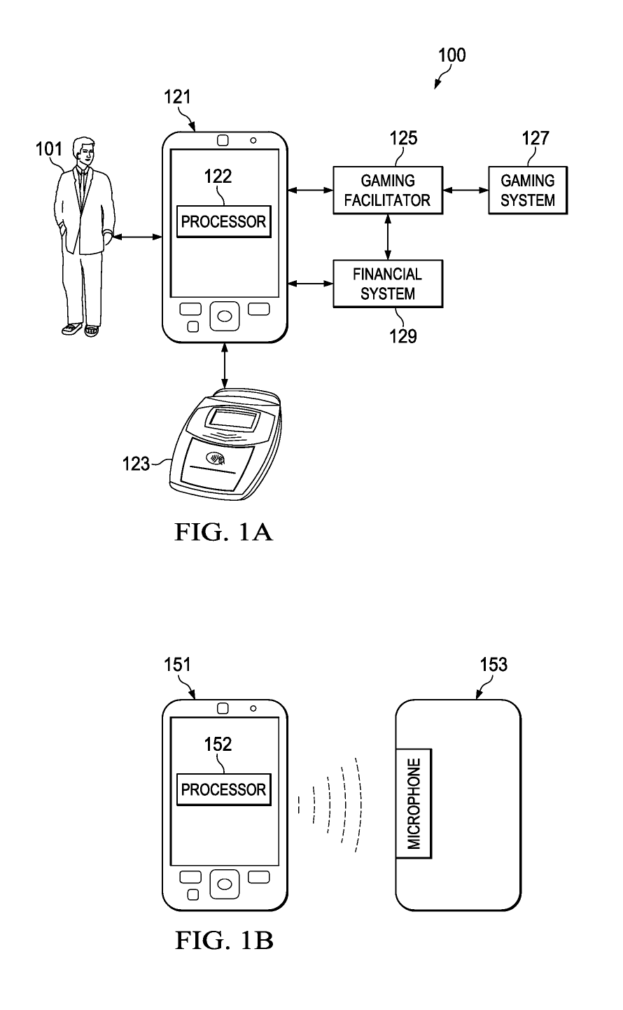

FIG. 1A is a schematic diagram illustrating a representative embodiment of a game play system 100. A user 101 may interact with a mobile device 121. The mobile device 121 may be, for example, a handheld device or smart phone that is already familiar to the user 101 and presents a familiar interface to lottery games. The mobile device 121 may include a processor 122 that is configured to execute programming that may be stored on and/or provided to the mobile device 121. The mobile device 121 is equipped to use proximity-based communication technology, thereby being able to communicate with a proximity-based communication enabled device 123. For example, in an embodiment, the mobile device 121 is equipped with Near Field Communication (NFC) technology and the proximity-based communication enabled device 123 is an NFC Transaction Anchor Point (TAP).

In another embodiment, the mobile device 121 is equipped with audio-frequency communication technology—such as Zoosh technology by Naratte—and the proximity-based communication enabled device 123 is an audio-frequency communication enabled device. FIG. 1B is a schematic diagram illustrating a mobile device 151 equipped with audio frequency communication technology, such as Zoosh technology, in communication with an audio-frequency communication enabled device 153. The mobile device 151 includes a processor 152 operable for encoding/decoding data based on audio-frequency digital signal processing protocols. The audio-frequency communication enabled device 153 includes a processor 154 operable for encoding/decoding data based on audio-frequency digital signal processing protocols. Zoosh technology audio-frequency communication is discussed in U.S. Patent Application Publication No. 2012/0134238 to Surprenant et al, which is herein incorporated by reference.

Referring back to FIG. 1A, by way of example, the proximity-based communication enabled device 123 may be located at an ATM, a gas pump, or any other proximity-based communication-enabled retail location. The mobile device 121 may be in communication with the gaming facilitator 125, which may be in communication with the gaming system 127. The mobile device 121 may also be in communication system with the financial system 129 directly and/or through the gaming facilitator 125. The financial system 129 may include, but is not limited to, payment processors, issuer banks, acquirer banks, payment rails, credit networks, etc. The gaming system 127 may include, but is not limited to, a gaming authority, a gaming operator (for example, state lottery operators), a gaming commission (for example, a state lottery commission), etc.

According to another embodiment, the game could be a location-specific game such as Keno or Bingo. In this embodiment, the gaming system 127 would be the computer or system that draws the number for game play. The gaming facilitator 125 would allow the user 101 to interact with the gaming system 127 through any of the proximity-based communication enabled devices located at the facility. Thus, a user 101 could select a series of numbers on the mobile device 121 and store those numbers for the next gaming play. At the appropriate time, the user 101 would bring the mobile device 121 in proximity to a proximity-based communication enabled device 123 to communicate the numbers to the gaming system 127 for play. For example, the user 101 may ‘TAP’ the mobile device 121 to an NFC enabled TAP.

### Communications Exchange Server

To sell gaming (or more particularly lottery) tickets through point of sale devices, a communication network is used for communications between a gaming facilitator and gaming partners. This communication network may have desirable characteristics such as being designed to be secure, reliable, and fast. In an embodiment, each gaming partner may have their own protocol for communicating with and between their systems, servers, and remote devices. Some gaming partners utilize public protocols (e.g., ISO8583) while other gaming partners have generated their own proprietary protocols. To ensure the security of each partner's data and protocols, a server for exchanging communications between a gaming facilitator and a gaming partner may be used.

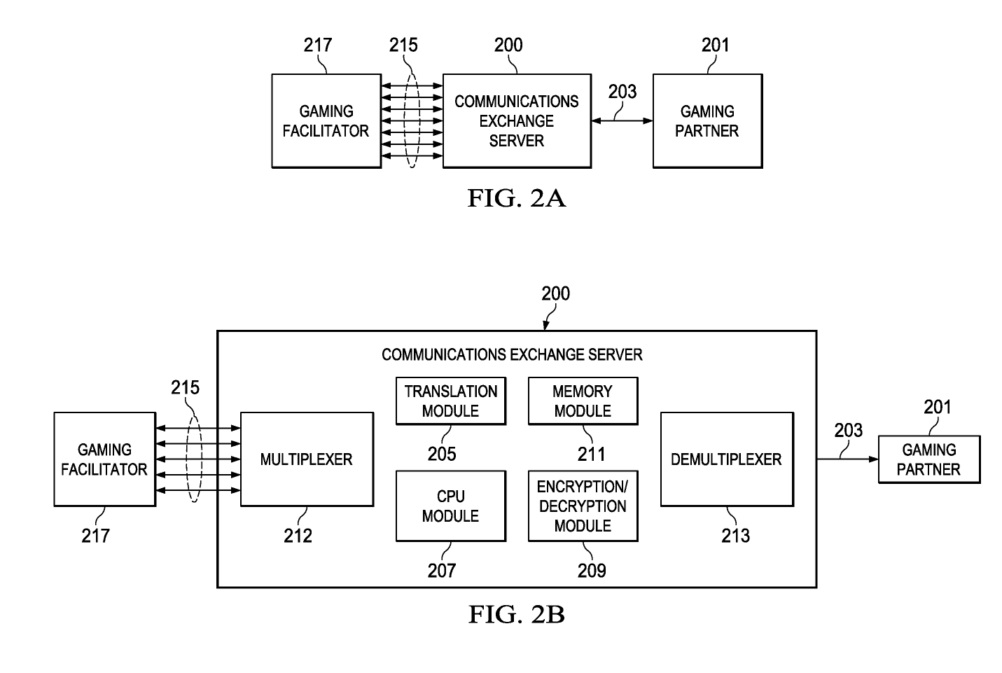

FIG. 2A is a schematic diagram of a communications exchange server 200 that exchanges communications between a gaming facilitator 217 and a gaming partner 201. The communications 203, 215 may include transaction-specific gaming information. In some embodiments, the communications exchange server 200 is an inbound communications server (as shown) for receiving and sending communications at a gaming facilitator 217 to and from a gaming partner 201. The communications 215 between the gaming facilitator 217 and the communications exchange server 200 are multiple connections which represents a series of parallel requests. The communications 203 between the communications exchange server 200 and the gaming partner 201 are a single connection which represents a series of serialized requests. In those embodiments, the communications exchange server may be located at the gaming facilitator.

In some embodiments, the communications exchange server 200 is an outbound communications server (not shown) for receiving and sending communications at a gaming facilitator 217 to and from a gaming partner 201. The communications between the gaming facilitator 217 and the communications exchange server 200 are a single connection which represents a series of serial requests. The communications between the communications exchange server 200 and the gaming partner 201 are multiple connections which represent a series of parallel requests. In those embodiments, the communications exchange server may be located at a gaming partner's site, for example, at a Lottery Operator. A gaming facilitator may send a single request to a communications exchange server that a Lottery Operator send a number of tickets (e.g., “give me 20 tickets”). The communications exchange server may turn that request into a number of requests for one ticket (e.g., 20 requests of, “give me one ticket”), resulting in a number of tickets (e.g., 20 tickets) being generated.

FIG. 2B is a more detailed schematic diagram of a communications exchange server 200 that exchanges communications between a gaming facilitator 217 and a gaming partner 201. The device 200 may include a translation module 205, encryption and decryption module 209, memory module 211, processing (CPU) module 207, multiplexer 212, and demultiplexer 213. The translation module 205 may translate communications between a gaming facilitator 217 and a gaming partner 201 by translating between a communication protocol used by the gaming partner 201 (e.g., a proprietary format of the gaming partner 201) and a communication protocol used by the gaming facilitator 217 (e.g., a proprietary format of the gaming facilitator 217). The encryption and decryption module 209 may encrypt and/or decrypt communications 215 between the gaming facilitator 217 and gaming partner 201. For example, data arriving at connection 215 from the gaming facilitator 217 may be encrypted. The encryption and decryption module 209 may decrypt the data such that it can be processed by the communications exchange server at the processor 207. Encryption keys may be used and may be updated at arbitrary times. Further, it may be desired that outgoing data at connection 215 to the gaming facilitator 217 or at connection 203 to the gaming partner 201 be encrypted before it is sent. Accordingly, the encryption and decryption module 209 may encrypt the data according to encryption protocols used by the gaming partner 201 and/or gaming facilitator 217. The memory module 211 may store information from the communications 203, 215 between the gaming facilitator 217 and gaming partner 201. The memory module 211 may also store gaming information. In an embodiment, the memory module 211 is a cache for storing gaming information and Bank Information. The cache 211 may store non-transaction specific gaming information. The cache 211 may also store game-related logic or a portion of game-related logic. The memory module 211 may also be program memory including logic or instructions accessible by the processor module 207. The processing module 207 may process the communications 203, 215 between the gaming partner 201 and the gaming facilitator 217. The translation module 205, encryption and decryption module 209, memory module 211, and processing module 207 are communicatively connected.

As discussed above, the communications exchange server 200 may be considered as an inbound or an outbound communications server. Inbound communications at connection 215, from one or more gaming partners 201 to gaming facilitator 217 may be multiplexed by the multiplexer 212. Outbound communications at connection 203 from the gaming facilitator 217 to the one or more gaming partners 201 may be demultiplexed by the demultiplexer 213.

FIG. 2B depicts a single translation module 205, memory module 211, CPU module 207, encryption and decryption module 209, and communications exchange server 200 for simplicity purposes only. At any point of connection between a gaming facilitator 217 and a gaming partner 201, multiple communications exchange servers 200 may be used for a variety of reasons including, but not limited to, redundancy, speed or efficiency of the system, failure diagnostics, ease of system upgradeability, system back-ups, network monitoring, etc. Further, each communications exchange server 200 may include multiple of any modules in the server 200. For example, in some embodiments, the communications exchange server 200 includes multiple memory modules 211 and multiple CPU modules 207. The communications exchange server 200 may be made of one or more machines, one or more motherboards, one or more memory modules, etc.

In an embodiment, the communications exchange server 200 is a computer that translates the gaming partner's communication protocol into a gaming facilitator specific protocol, thereby substantially eliminating the exposure of the partner's protocol to an outside entity. A communications exchange server 200 may be placed at a gaming partner's data center, either inside or outside of the gaming partner's firewall depending upon a gaming partner's preference. The communications exchange server 200 connects to gaming facilitator data centers over a gaming facilitator provided connection. In an embodiment, the gaming facilitator provided connection is a high speed, private connection (e.g., an MPLS connection). While this type of connection provides some inherent security, communications to and from the gaming facilitator may be encrypted to provide an additional layer of protection.

Non-transaction specific information (images, game rules, game information, etc.) may be cached on the device 200 in memory module 211, which allows for rapid access to cached data. For transaction specific information, data may be passed from the gaming partner 201 to the communications exchange server 200 which then encrypts the data and passes the request to a gaming facilitator 217 via a gaming facilitator provided connection.

The communications exchange server 200 may be used with a variety of gaming partners 201 including, but not limited to, lottery authorities, banking systems, and other payment systems. Further, the communications exchange server 200 may be located at a gaming partner location or at a gaming facilitator location.

### User Registration

In an embodiment, a gaming facilitator system may include a user registration server. The user registration server allows users to register with the gaming facilitator system. Registering may allow users to check to see their play history, set spending limits, to select favorite numbers to be played, and to configure how they wish to be notified of their play status. In an embodiment, users may have an online account with the gaming facilitator system in which they may register, configure and make selections for their account with the gaming facilitator system.

Information identifying the registration of the associated information (the play history, spending limits, favorite numbers, notification configuration, etc) may be stored on the gaming facilitator system or on the mobile device 121 as a part of or in association with a gaming application stored on the mobile device 121.

### Play Overview

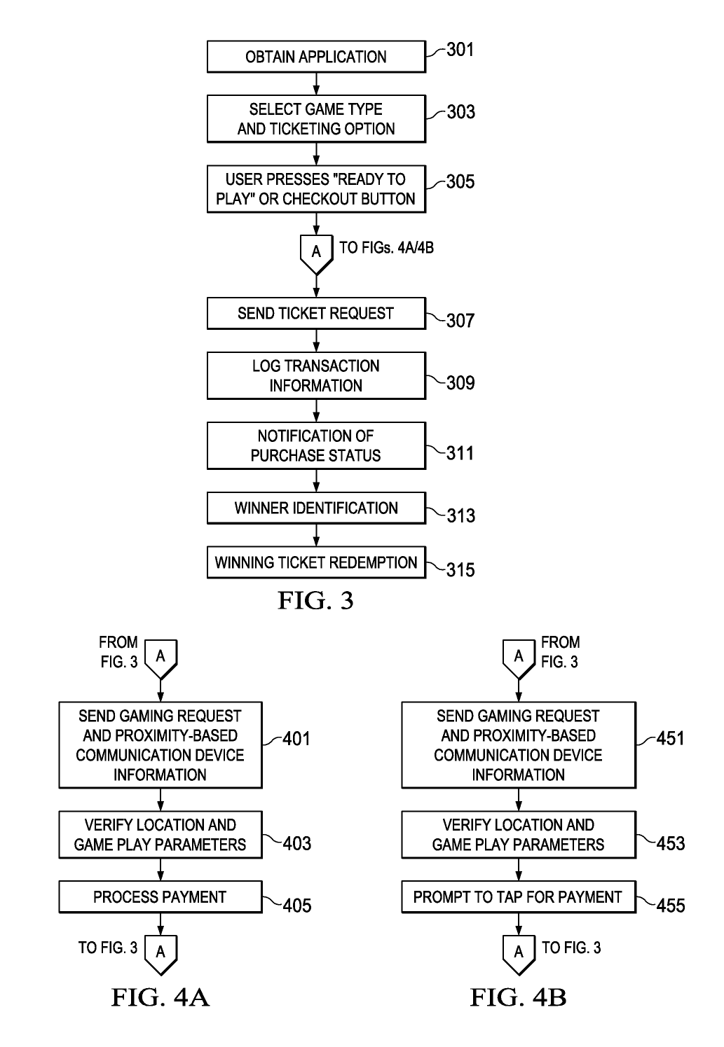

FIG. 3 is a high-level flow diagram illustrating a process for a gaming system transaction such as a lottery transaction. At action 301, the mobile device 121 obtains the gaming application. The application may be obtained directly or indirectly from the gaming facilitator 125. The gaming application can be obtained at anytime prior to gaming purchase.

The action 301 may be omitted if the mobile device already has the gaming application. For example, the gaming application may be preloaded on the mobile device 121 at the time of purchase of the mobile device 121.

At action 303, the user 101 selects a game type and ticketing option for gaming play. Game types include but are not limited to lottery play including draw, instant, and any other games offered by the jurisdiction's gaming authority. Other games may include location-specific games, such as Keno or Bingo. The jurisdiction's gaming authority may limit the available game types to approved game types. The selecting of ticketing options may include a number of tickets, numbers played, etc.

In some embodiments, the user 101 can select the game type and ticketing options at any time and in any location even prior to entering an approved retail location that has the proximity-based communication enabled device 123. In these embodiments, the gaming application may store the selected game type and ticketing options in, for example, a virtual shopping cart to be recalled at a later time to complete the transaction. The gaming application may also record previous selections and favorite selections such as favorite numbers to allow easier selection by the user 101.

At action 305, the end user presses a “ready to play” or checkout button in the mobile application and brings the mobile device 121 in proximity to the proximity-based communication enabled device 123. In an embodiment, the user taps an NFC enabled mobile device to an NFC TAP. Since the proximity-based communication enabled devices use proximity detection protocols for the handset or mobile device, the game play system 100 verifies the location of the mobile device 121 and facilitates the user 101's gaming purchase using a method such as those described in FIGS. 4A and 4B.

Location verification can also be performed using other “mobile wallet” technologies—including, but not limited to, the use of bar codes, audio signatures, and other proximity-based communication technologies. Naratte's “Zoosh” technology enables wireless transactions using an audio frequency range just above the upper end of human hearing. Data may be securely transmitted between two handsets in sufficiently close proximity or between a handset and a point-of-sale terminal in sufficiently close proximity, leveraging the microphones and speakers in existing mobile electronic devices to for proximity-based audio-frequency communication.

FIG. 4A is a flow diagram illustrating a first exemplary method for verifying the location of the mobile device 121 and facilitating the user 101's gaming purchase.

At action 401, the gaming application sends a gaming request including the selected game type and ticketing option along with the location of the proximity-based communication enabled device 123 to the gaming facilitator 125 using a mobile network such as Wi-Fi or CDMA/GSM.

In another embodiment, the mobile application provides information identifying the selected game type and ticketing option to the proximity-based communication enabled device 123 and the proximity-based communication enabled device 123 sends the gaming request to the gaming facilitator 125. Alternatively, the mobile application may provide the gaming request to the gaming facilitator 125 and the proximity-based communication enabled device 123 may provide information identifying the proximity-based communication enabled device 123, which can be used to identify and verify the location of the proximity-based communication enabled device 123, to the gaming facilitator 125.

At action 403, the gaming facilitator 125 processes a location verification of the proximity-based communication enabled device 123, checks game availability, play limits and other lottery game play parameters. Location verification can be performed by a variety of means. According to one embodiment, the merchant may be required to be included on a list of pre-approved merchants to vend gaming tickets at the proximity-based communication enabled device location. This list can be maintained by an appropriate authority, such as a facilitator or gaming authority. According to another embodiment, location verification can be performed by other technology within the mobile device, such as GPS or radio tower triangulation. Ultimately, most gaming facilitators should take sufficient steps to confirm that the purchaser of the tickets is physically located within the jurisdiction of the gaming authority to avoid any legal complications associated with selling gaming tickets outside of the jurisdiction of the gaming authority. Proximity-based communication technologies—such as NFC and Zoosh—may provide for such location verification.

At action 405, the gaming facilitator 125 processes transaction payment through, for example, an integrated standardized ticketing system with secure “mobile wallet” platforms or a direct gateway to payment processing partners. The proximity-based communication enabled device 123 and the mobile application may also process payment using other methods at a retail location. In some embodiments, the gaming facilitator 125 communicates with the payment processing partners to obtain payment.

FIG. 4B is a flow diagram illustrating a second exemplary method for verifying the location of the mobile device 121 and facilitating the user 101's gaming purchase.

At action 451, the gaming application sends a gaming request including the selected game type and ticketing option along with the location of the proximity-based communication enabled device 123 to the gaming facilitator 125 using a mobile network such as Wi-Fi or CDMA/GSM.

In another embodiment, the mobile application provides information identifying the selected game type and ticketing option to the proximity-based communication enabled device 123 and the proximity-based communication enabled device 123 sends the gaming request to the gaming facilitator 125. Alternatively, the mobile application may provide the gaming request to the gaming facilitator 125 and the proximity-based communication enabled device 123 may provide information identifying the proximity-based communication enabled device 123, which can be used to identify and verify the location of the proximity-based communication enabled device 123, to the gaming facilitator 125.

At action 453, the gaming facilitator 125 processes a location verification of the proximity-based communication enabled device 123, checks game availability, play limits and other lottery game play parameters.

At action 455, the mobile application prompts the user 101 to bring in proximity or tap the mobile device 121 to the proximity-based communication enabled device 123 again for payment authorization through a retailer payment gateway.

In some embodiments, the proximity-based communication enabled device 123 is also an NFC enabled credit payment device. Therefore, the mobile device 121 can provide payment through the use of, for example, a “mobile wallet” platform.

Returning now to FIG. 3, at action 307, upon payment authorization, the gaming facilitator 125 sends the ticket request to a computerized gaming system (CGS), such as gaming system 127. The gaming system may use a Random Number Generator (RNG) to produce the gaming play. In an embodiment using a “Virtual Instant Ticket,” the RNG may not be used but the purchase will be sent to the CGS for processing and balancing. The gaming system 127, in communication with the gaming facilitator 125, verifies and completes the gaming transaction. According to another embodiment, pre-existing or favorite numbers can be entered or stored in the mobile device 121 or at the gaming facilitator 125. These numbers are sent to the gaming system 127 at step 307.

At action 309, the gaming facilitator 125 sends the gaming transaction information to the Internal Control System (ICS) of the gaming system 127 for independent logging. This action is not always requested and may not be present in some embodiments.

At action 311, the gaming facilitator 125 sends a notification of the purchase status to the gaming application. This notification may include, for example, numbers played, ticket serial number, date of draw, and payment authorization code along with other transaction specific information. In some embodiments the notification includes a numeric redemption code, a scannable barcode such as a QR code, or any other type of redeemable code that can be securely sent to the mobile application along with the notification. The barcode or redemption code can be used after a draw to check and claim winning numbers at an existing gaming/lottery terminal or retail location.

In the case where the transaction was not able to be completed, information notifying of the failure to complete may be sent to the mobile device 121. The notification may include other information associated with the failure, for example, what exception caused the failure.

In some embodiments, automated paperless receipts are provided to indicate numbers and games played. This notification may be sent via multiple methodologies including email, wireless delivery to mobile devices utilizing SMS text or device specific applications, RSS feed, or feeds into Twitter, Facebook or other social media accounts.

The notification may also include an automated remote notification that may be sent to the user 101 indicating play status (winner, winner of a certain amount of money, winner with manual redemption, non-winner, winning numbers, what the winning numbers were if the game was lost, game jackpots, game statistics, and other statistics). Notifications may be sent directly to the user 101 through the gaming application as well as via wireless delivery to a mobile device or email address using, for example, SMS text, email, RSS feed to Twitter, Facebook or other social media account, through device specific apps (i.e. iPhone, BlackBerry, or PDA apps) and, through automated lottery system web sites.

### Redemption

When the user 101 wins a game, the user 101 will want to redeem his or her winnings. At action 313, a winner identification interface of the mobile application utilizes transaction data to query data from the gaming facilitator 125 to find winning ticket numbers. The data may be separated into three categories: non-winning tickets, winning tickets available for auto-redemption, and winning tickets available for manual claims. An additional winner verification system that a lottery facilitator may provide may be used by a game administrator to verify the integrity of tickets and to validate that a presented ticket is a winner for items that are manually claimed. The gaming facilitator 125 obtains the queried data from the gaming system 127 and provides it to the mobile application.

At action 315, the mobile application facilitates the redemption of winnings. Redemption may be completed using a variety of methods selected based on, for example, a selection of a preferred method by the user 101 or the amount of the winnings.

As a first example, the mobile application may provide for the display of the barcode received in the notification in connection with action 311. A retail location can then read the barcode to verify the win and provide the winnings.

As a second example, the winnings are automatically deposited to an account associated with the user 101. In some embodiments, the user 101 may tap the mobile device 121 to the proximity-based communication enabled device 123 to initiate a transfer of funds through financial system 129. A “mobile wallet” system may also be accessed for an auto-deposit of winning tickets through a point of sale terminal, debit, and/or credit network to allow for the redemption of winning tickets under a taxable or manually verifiable limit via a pin-less debit card or credit card transaction. A unique terminal number may be used for this transaction, and a pin or card may or may not be used for completion of the transaction.

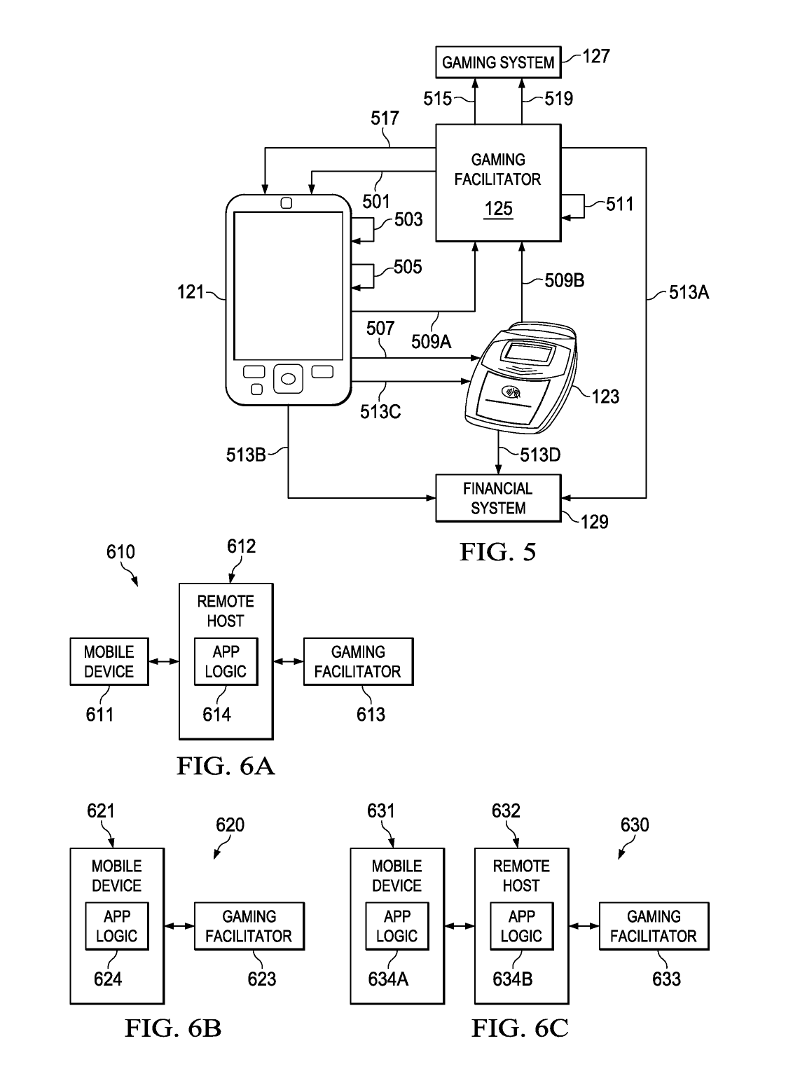

FIG. 5 is a schematic diagram illustrating a process for a game play. At action 501, the mobile device 121 downloads the mobile application from the gaming facilitator 125. At action 503, the user 101 uses the mobile application running on the mobile device 121 to select game play and ticketing options. The user 101 may make the game play and ticketing option selections at anytime prior to entering an approved retail location that has the proximity-based communication enabled device 123. In an embodiment, the proximity-based communication enabled device 123 is an NFC TAP. In other embodiments, the device 123 is an audio-frequency communication enabled device. In still other embodiments, the device 123 is any device that can receive proximity-based communications from a mobile device 121.

At action 505, the user 101 presses a checkout or ready to play button displayed on the mobile device 121. At action 507, the user brings the mobile device 121 in proximity to the proximity-based communication enabled device 123. For example, in an embodiment, the user taps the device to an NFC TAP. In response, at action 509A, the mobile device 121 sends a request associated with the game play request to the gaming facilitator 125 and at action 509B, the proximity-based communication enabled device 123 sends information identifying the proximity-based communication enabled device 123 to the gaming facilitator 125.

At action 511, the gaming facilitator 125 verifies the location of the mobile device 121 based on the information provided by the proximity-based communication enabled device 123. As mentioned previously, the physical location of the user and the mobile device at the time of the payment transaction can have implications for the legality of the transaction, depending upon the laws of the jurisdiction in which the gaming authority is operating.

At action 513A, the gaming facilitator 125 processes payment authorization through a direct gateway with financial system 129. In other embodiments, payment may be processed directly between the mobile device 121 and the financial system 129 as shown in action 513B. In still other embodiments, payment may be processed by tapping the mobile device 121 to the proximity-based communication enabled device 123 as shown in action 513C. In this embodiment, the proximity-based communication enabled device 123 initiates the payment instruction to the financial system 129, as shown in action 513D.

At action 515, the gaming facilitator 125 sends a ticketing request to the gaming system 127, for example the lottery authority in the jurisdiction, verifies and completes the gaming transaction.

At action 517, the gaming facilitator 125 sends ticket information and confirmation to the mobile device 121.

At action 519, the gaming facilitator 125 sends gaming processing and balancing information including transaction logs to the gaming system 127.

The above-described playing process allows for gaming purchases such as lottery games on mobile devices while providing the assurances and verification that the sale of the gamine products occurred within the borders of the government regulating the games.

In some embodiments, the gaming facilitator 125 provides a retailer signup program as part of the mobile application. Prior to the sale of gaming (e.g., lottery) tickets at a location of a particular proximity-based communication enabled device 123, the retail location or merchant may be required to be included on a list of pre-approved locations or merchants. This list can be maintained by an authority appropriate to ensure that the geographic location of the proximity-based communication enabled device 123 has been confirmed. This could be the gaming facilitator or the gaming authority.

Embodiments of the proximity-based communication enabled device 123 may include an existing device at a retailer, a dedicated gaming/lottery device at the retailer, or a device placed in conjunction with a new or existing lottery terminal.

### Application Logic

Lottery system logic may reside at a device associated with the lottery system, such as the proximity-based communication enabled device or the gaming facilitator, within the gaming application on the mobile device, or both at the device and the host.

FIG. 6A is a schematic diagram illustrating a host-based input system 610. With the host-based terminal 610, the mobile device 611 is a user input/display device. The application logic 614 that determines what happens with each input and provides decision-making for what to display to the user occurs on a remote host 612. The host 612 contains automated lottery system logic and may gather the user input by providing the appropriate screens to the mobile device 611 (for example, to a gaming application running on the mobile device 611) and forwarding the user input to the gaming facilitator 613 either through an intermediary communications exchange server (not shown) or to the gaming facilitator 613 directly.

FIG. 6B is a schematic diagram illustrating a terminal-based input system 620. Terminal-based input systems have automated lottery system application logic 624 on the mobile device 621, for example as part of the mobile application stored on the mobile device 621. Accordingly, the mobile device 621 has the ability to walk a user through the game process and may then send the information that the user has selected to a gaming facilitator 623 either through an intermediary communications exchange server (not shown) or to the gaming facilitator directly.

FIG. 6C is a schematic diagram illustrating a hybrid-based input system 630. Hybrid-based input systems have some application logic 634A stored at the mobile device 631, for example as part of the mobile application stored on the mobile device 631, to gather user input and display the game specific parameters, but also rely on some application logic 634B stored at a remote host 632 to control the automated lottery system flow. An example of this is a cell phone with an automated lottery system application where the application on the phone controls the layout of the screen, receives user input, and performs basic validation (e.g., prevents the user from inputting text into numeric fields). But the cell phone may communicate with a host 632 to determine the order of the screens to display. The remote host 632 may communicate with a gaming facilitator 633 either through an intermediary communications exchange server (not shown) or with the gaming facilitator directly.

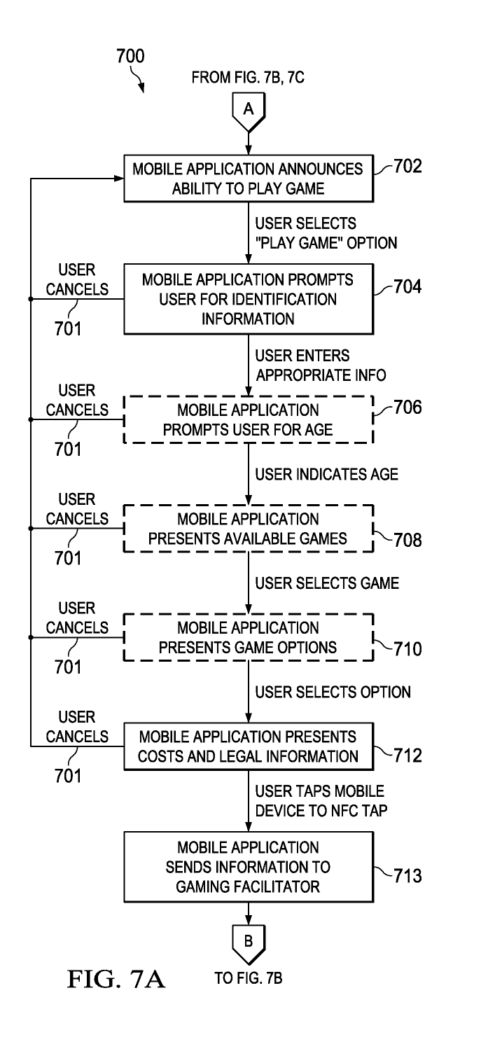

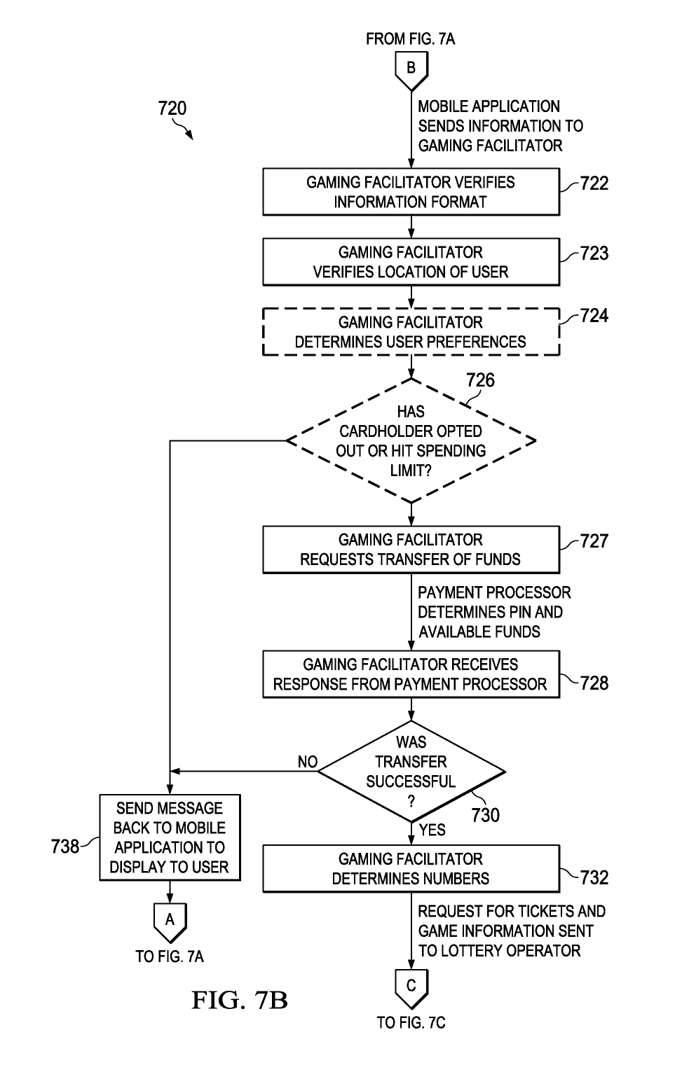

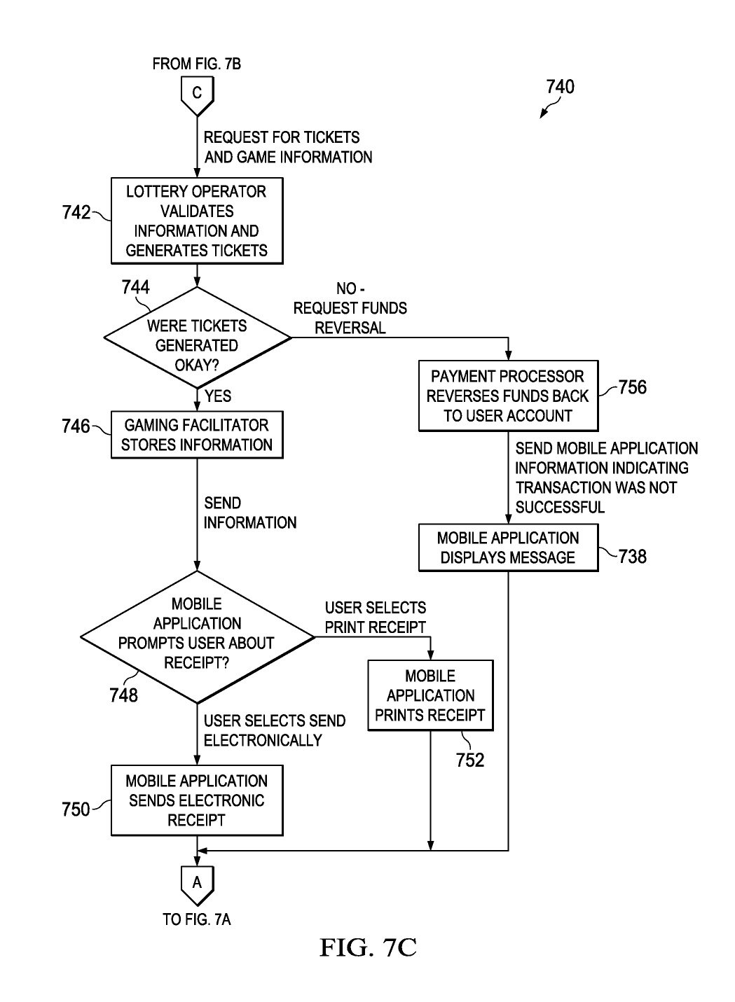

FIGS. 7A, 7B, and 7C are flow diagrams 700, 720, 740 illustrating a process for a mobile application-based play of an lottery system presented game. At action 702, a mobile application announces the ability for a user to play a game. In some embodiments, the mobile application may present a screen indicating that the mobile application is capable of providing game plays to the user. If a user decides to play a game, the mobile application requests that the user input identification information at action 704. For example, the mobile application may ask the user for their preferred language at action 704. For example, the mobile application may request that the user swipe a debit card and enter their debit card pin or provide information regarding an account with a “mobile wallet” platform at action 704.

The mobile application may optionally request that the user verify their age at action 706 if the user's age has not been verified by previous input at the mobile application. The mobile application may also optionally present a list of game options available through the mobile application at action 708. The list may include games that will become available at a future time and an indication that those games will be available in the future.

At action 710, the mobile application may present options for the selected game. For example, the mobile application may present the number of tickets available for purchase, game play times available, etc. at action 710. The terminal may also ask the user whether they would like to have their numbers sent to them or a link to their numbers sent to them. The mobile application presents the cost associated with the user's selections as well as any necessary legal disclosures at action 712. At any point in the process, the user may cancel the transaction at action 701.

The user brings a mobile device running the mobile application in proximity to a proximity-based communication enabled device, and at action 713, the mobile application sends gaming information collected from the user to a gaming facilitator at action B. For example, in an embodiment, the user taps an NFC enabled mobile device to an NFC TAP.

The gaming facilitator may verify information format of the information sent by the terminal at action 722. For example, at action 722, the gaming facilitator may determine whether the information is sufficient and complete for a certain game play. The gaming facilitator may also ensure that the information is not corrupt. The gaming facilitator may also verify a user's age if their driver's license was presented at the terminal. If a driver's license is required by the game, but was not presented at the terminal, the gaming facilitator may cancel the transaction. If the transaction is canceled, the terminal may display a cancel message indicating the reason for the cancellation.

At action 723, the gaming facilitator verifies the location of the user. For example, the gaming facilitator may verify the location of the proximity-based communication enabled device by referring to a pre-approval of the proximity-based communication enabled device with the gaming facilitator and/or the lottery authority.

At optional action 724, the gaming facilitator may look up the user to determine preferences for that user. These preferences can include a list of pre-stored or favorite numbers to be used in the game play. Other preferences can include whether the user desires automatic redemption of winning plays, or manual redemption through the delivery of a redemption code to the mobile device 121.

At optional action 726, the gaming facilitator may determine whether the user has opted out of the gaming system, whether the user has already hit their spending limit for a certain time period, etc. If either determination is affirmatively made at optional action 726, then the gaming facilitator sends a message back to the mobile application to display to the user at action 738 and the process may begin again with the same or a new user at action A. If the determination is not affirmatively made at optional action 726, then the process continues.

At action 727, the gaming facilitator may request a transfer of funds for the transaction. For example, the gaming facilitator may request that a payment processor verify the user PIN number, whether enough funds are available in the user account for the transaction, and to transfer the funds. The payment processor determines whether the pin is correct and whether funds are available and sends a response to the gaming facilitator. The gaming facilitator receives the response from the payment processor at action 728. The response may include, for example, verification from the payment processor whether the PIN is correct, whether funds are available, and/or whether the funds were transferred. If the gaming facilitator receives verification that the PIN is correct, that sufficient funds are available, and that the funds have been transferred at action 730, the gaming facilitator generates random numbers or uses user-specified numbers for the game play at action 732. If the gaming facilitator receives notification that the PIN is incorrect, that sufficient funds are not available, or that the funds were not transferred at action 730, the gaming facilitator sends a message back to the terminal to display to the user at action 738 and the process may begin again with the same or a new user at action A. A request for the desired number of tickets and games along with game information is sent by the gaming facilitator to the lottery operator at action C.

In some embodiments, the user is instructed to tap the—mobile device running the mobile application to the proximity-based communication enabled device again to process payment through the proximity-based communication enabled device. The proximity-based communication enabled device may be a NFC enabled credit payment device or may be configured to operate with a “mobile wallet” platform to effectuate payment.

The lottery operator validates information received from the gaming facilitator and generates tickets if the information is validated at action 742. The gaming facilitator determines whether the tickets were generated correctly at action 744. If the tickets were not generated correctly, the gaming facilitator requests a funds reversal to the payment processor, and the payment processor may reverse the funds back to the user account at action 756. The gaming facilitator sends a message back to the mobile application to display to the user at action 738 and the process may begin again with the same or a new user at action A. If the tickets were generated correctly, the gaming facilitator will store game play information at action 746. The gaming facilitator sends to the terminal game play numbers, transaction numbers, and a confirmation of the transaction. The mobile application may prompt the user to indicate whether to receive a receipt electronically or obtain a barcode for use in redeeming winnings at action 748. If the mobile device is equipped with a printer or configured to access a printer, the mobile application may prompt the user to indicate whether to receive a printed receipt. If the user selects to print the receipt, the terminal prints the receipt at action 752 and the process may begin again with the same or a new user at action A. If the user selects to receive the receipt electronically, the terminal gathers user information and sends the electronic receipt at action 750. The process may begin again with the same or a new user at action A.

Host-based mobile applications are mobile applications that receive instructions from a host instead of having internal local logic. Accordingly, a process for a host-based play of a lottery system presented game is slightly different than the mobile application-based play. A host-based terminal is connected to a host from the beginning of a transaction or at each step requiring new information between user actions, whereas a mobile application-based terminal might connect to the host or to a gaming facilitator after certain decisions and actions are taken by a user during a transaction. Being connected earlier allows the host-based mobile application to query a gaming facilitator database for information about the user at an earlier time in the transaction. This is also the case for mobile application-based play flow where the mobile application has a substantially constant connection such as with a network connection like Wi-Fi or CDMA/GSM.

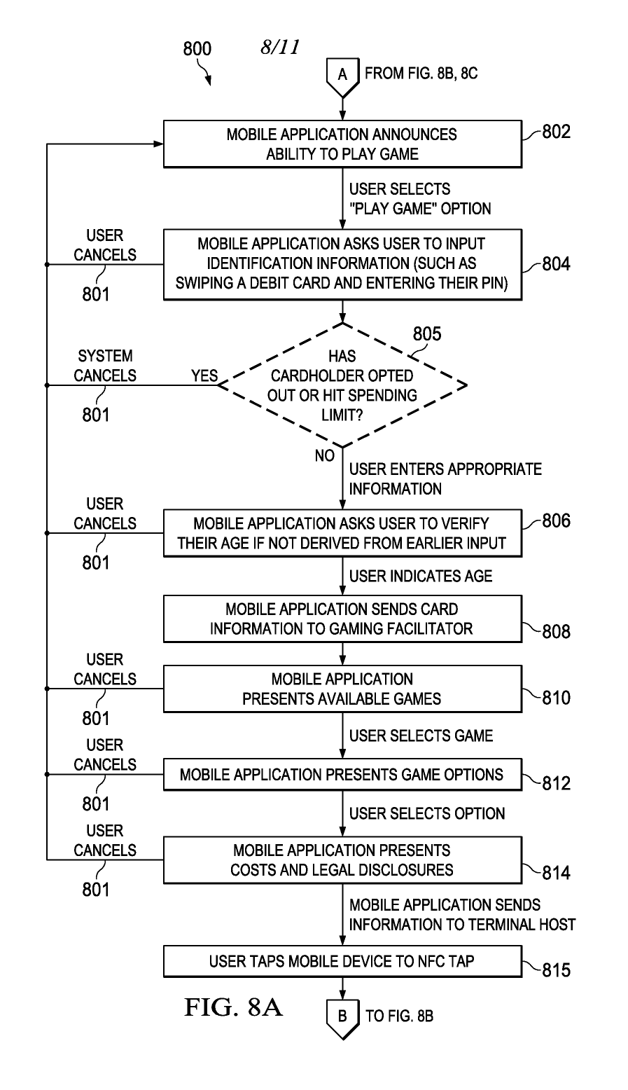

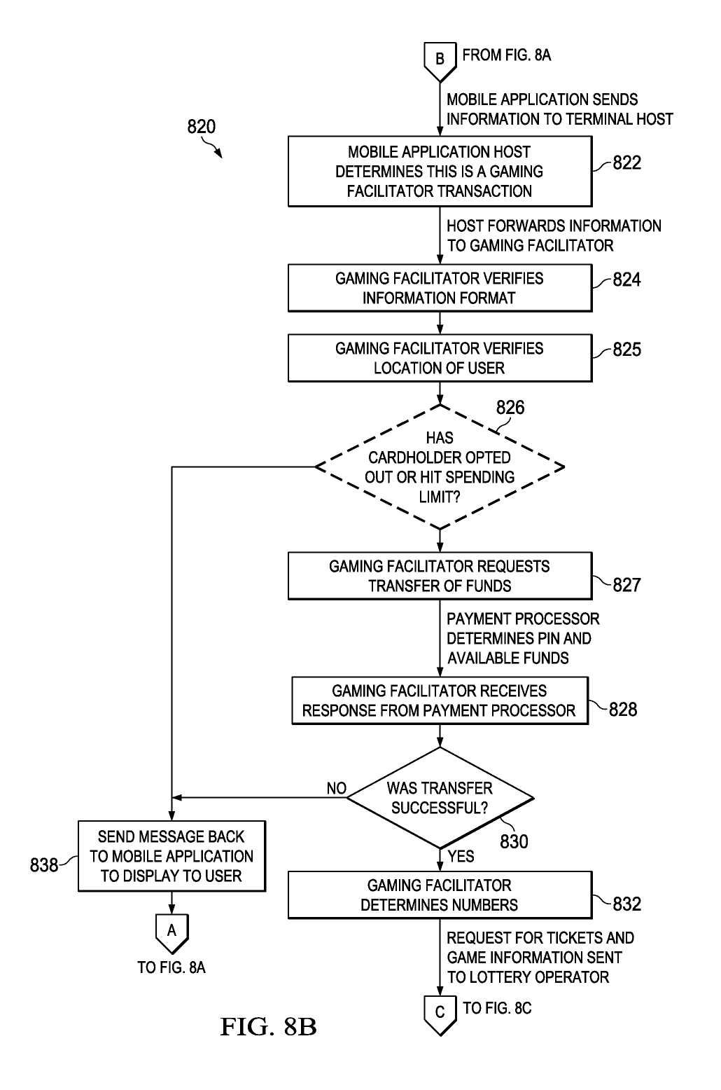

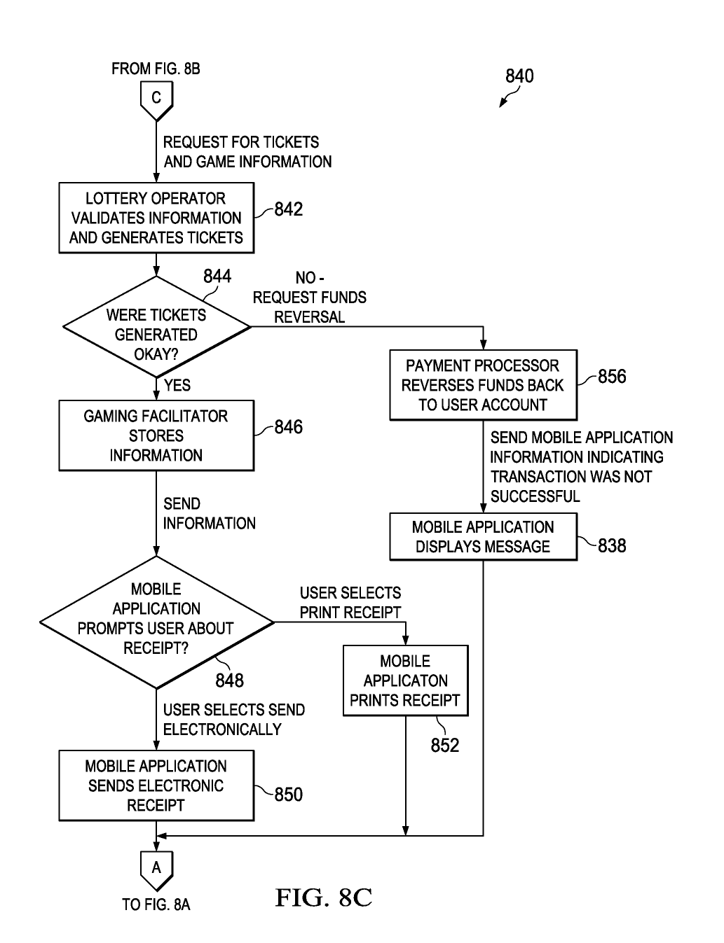

FIGS. 8A, 8B, and 8C are flow diagrams 800, 820, 840 illustrating a process for a host-based play (and mobile application-based play where the mobile application has a substantially constant connection) of an automated lottery system presented game. At action 802, a mobile application announces the ability for a user to play a game. For example, the mobile application may present a screen indicating that the mobile application is capable of providing game plays to the user. If a user decides to play a game, the mobile application requests that the user input identification information at action 804. In some embodiments, the mobile application may ask the user for their preferred language at action 1104. In some embodiments, the mobile application may request that the user swipe a debit card and enter their debit card pin or provide information regarding an account with a “mobile wallet” platform at action 804.

In an embodiment, at optional action 805, the gaming facilitator may determine whether the user has opted out of the automated gaming system, whether the user has already hit their spending limit for a certain time period, etc. If either determination is affirmatively made at optional action 805, then the gaming facilitator system cancels the transaction at action 801. The system may send a message back to the mobile application to display to the user and the process may begin again with the same or a new user at action A. If the determination is not affirmatively made at optional action 805, then the process continues at action 806.

The mobile application also requests that the user verify their age at action 806 if the user's age has not been verified by previous input at the terminal. The mobile application sends card information to a gaming facilitator (via a mobile device) at action 808 to determine whether the user is a registered user. The mobile application may present a list of game options available at the user's location at action 811. The list may include games that will become available at a future time and an indication that those games will be available in the future. At action 812, the mobile application may present options for the selected game. For example, the mobile application may present the number of tickets available for purchase, game play times available, etc. at action 812. The mobile application may also ask the user whether they would like to have their numbers sent to them or a link to their numbers sent to them. The mobile application presents the cost associated with the user's selections as well as any necessary legal disclosures at action 814. At any point in the process, the user may cancel the transaction at action 801.

The user brings a mobile device running the mobile application in proximity to a proximity-based communication enabled device, and at action 815, the mobile application sends gaming information collected from the user to a terminal host at action B. For example, in an embodiment, the user taps an NFC enabled mobile device to an NFC TAP.

At action 822, a terminal host determines based on the information sent from the mobile application that the transaction is a gaming facilitator transaction. The host may forward the information to the gaming facilitator. The gaming facilitator may verify information format of the information sent by the mobile application at action 824. For example, at action 824, the gaming facilitator may determine whether the information is sufficient and complete for a certain game play. The gaming facilitator may also ensure that the information is not corrupt. The gaming facilitator may also verify a user's age if their driver's license was presented at the terminal. If a driver's license is required by the game, but was not presented at the terminal, the gaming facilitator may cancel the transaction. If the transaction is canceled, the terminal may display a cancel message indicating the reason for the cancellation.

At action 825, the gaming facilitator verifies the location of the user. For example, the gaming facilitator may verify the location of the proximity-based communication enabled device by referring to a pre-approval of the proximity-based communication enabled device with the gaming facilitator and/or the lottery authority.

In an embodiment, at optional action 826, the gaming facilitator may look up the user to determine preferences for that user. At action 826, the gaming facilitator may determine whether the user has opted out of the gaming system, whether the user has already hit their spending limit for a certain time period, etc. If either determination is affirmatively made at action 826, then the gaming facilitator sends a message back to the mobile application (e.g., via the mobile device) host to display to the user at action 838 and the process may begin again with the same or a new user at action A. If the determination is not affirmatively made at action 826, then the process continues.

At action 827, the gaming facilitator may request a transfer of funds for the transaction. For example, the gaming facilitator may request that a payment processor verify the user PIN number, whether enough funds are available in the user account for the transaction, and to transfer the funds. The payment processor determines whether the pin is correct and whether funds are available and sends a response to the gaming facilitator. The gaming facilitator receives the response from the payment processor act action 828. The response may include, for example, verification from the payment processor whether the PIN is correct, whether funds are available, and/or whether the funds were transferred.

The gaming facilitator receives verification from the payment processor whether the PIN is correct, whether funds are available, and/or whether the funds were transferred at action 828. If the gaming facilitator receives verification that the PIN is correct, that sufficient funds are available, and that the funds have been transferred at action 830, the gaming facilitator generates random numbers or uses user-specified numbers for the game play at action 832. If the gaming facilitator receives notification that the PIN is incorrect, that sufficient funds are not available, or that the funds were not transferred at action 830, the gaming facilitator sends a message back to the terminal (e.g., via the terminal host) to display to the user at action 838 and the process may begin again with the same or a new user at action A. A request for the desired number of tickets and games along with game information is sent by the gaming facilitator to the lottery operator at action C.

In some embodiments, the user is instructed to tap the mobile device running the mobile application to the proximity-based communication enabled device again to process payment through the proximity-based communication enabled device. The proximity-based communication enabled device may be a NFC enabled credit payment device or may be configured to operate with a “mobile wallet” platform to effectuate payment.

The lottery operator validates information received from the gaming facilitator and generates tickets if the information is validated at action 842. The gaming facilitator determines whether the tickets were generated correctly at action 844. If the tickets were not generated correctly, the gaming facilitator requests a funds reversal to the payment processor, and the payment processor may reverse the funds back to the user account at action 856. The gaming facilitator sends a message back to the terminal to display to the user at action 838 and the process may begin again with the same or a new user at action A. If the tickets were generated correctly, the gaming facilitator will store game play information at action 846. The gaming facilitator sends to the terminal (e.g., via the terminal host) game play numbers, transaction numbers, and a confirmation of the transaction. The terminal may prompt the user to indicate whether to print a receipt at the terminal or receive a receipt electronically at action 848. If the user selects to print the receipt, the terminal prints the receipt at action 852 and the process may begin again with the same or a new user at action A. If the user selects to receive the receipt electronically, the terminal gathers user information and sends the electronic receipt at action 850. The process may begin again with the same or a new user at action A.

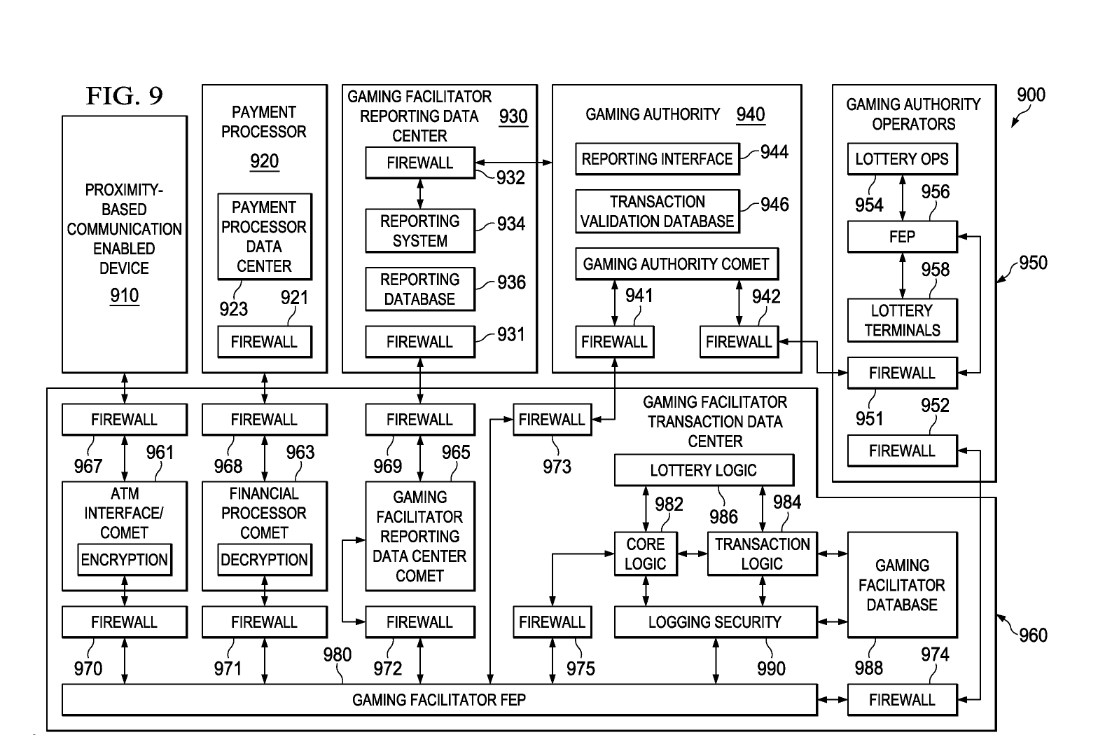

FIG. 9 is a schematic diagram illustrating a gaming facilitator system 900. System 900 may include a proximity-based communication enabled device 910, a payment processor 920, a gaming facilitator reporting data center 930, a gaming authority 940, gaming authority operators 950 and gaming facilitator transaction data center 960. In an embodiment, the proximity-based communication enabled device 910 is an NFC TAP. In another embodiment, the proximity-based communication enabled device 910 is an audio-frequency communication enabled device.

The gaming facilitator transaction data center 960 is in communication with the proximity-based communication enabled device 910, the payment processor 920, the gaming facilitator reporting data center 930 and the gaming authority 940. Using alternative connectivity, the gaming facilitator transaction data center 960 may be in communication with the gaming authority operators 950. In some embodiments, the communication with the gaming facilitator transaction data center 950 may be made via communications exchange servers 961, 963 and 965. Firewalls 921, 931, 941, 942, 951, 952 and 967-974 provide isolation between various systems and components in the system 900.

The payment processor 920 may include payment processor data center 923. The payment processor 920 connects with the gaming facilitator transaction data center 960 via a secure connection (e.g., MPLS or other “private” connection) between the firewall 921 at the payment processor 920 and the firewall 968 at the gaming facilitator transaction data center 960.

The gaming facilitator reporting data center 930 may include reporting system 934 and reporting database 936. The gaming facilitator reporting data center 930 connects with the gaming facilitator transaction data center 960 via a secure connection (e.g., MPLS or other “private” connection) between the firewall 931 at the gaming facilitator reporting data center 930 and the firewall 969 at the gaming facilitator transaction data center 960.

The gaming authority 940 may include a reporting interface 944 and a transaction validation database 946. The gaming authority 940 connects with the gaming facilitator transaction data center 960 via a secure connection (e.g., MPLS or other “private” connection) between the firewall 941 at the gaming authority 940 and the firewall 973 at the gaming facilitator transaction data center 960. Also, the gaming authority 940 connects with the firewall 932 of the gaming facilitator reporting data center 930 via a secure connection (e.g., MPLS or other “private” connection.

The gaming authority operators 950 may include a lottery ops (operations) 954, an FEP 956 and lottery terminals 958. The lottery ops 954 is in communication with the FEP 956, which is in communication with the lottery terminals 958. The gaming authority operators 950 connects with the gaming authority 950 via a secure Ethernet connection (e.g., B to B API) between the firewall 942 at the gaming authority 940 and the firewall 951 at the gaming authority operators 950. Alternate connectivity may be provided between the firewall 974 of the gaming facilitator transaction data center 960 and the firewall 952 of the gaming authority operators 950.

The gaming facilitator transaction data center 960 may include a gaming facilitator FEP 980, core logic 982, transaction logic 984, lottery logic 986, a gaming facilitator database 988 and logging security 990. The core logic 982, the transaction logic 984 and the lottery logic 986 are in communication with one another. The core logic 982 is in communication with the gaming facilitator FEP 980 through firewall 975. The gaming facilitator database 988 is in communication with the transaction logic 984. The logging security 990 is in communication with the gaming facilitator 980, the core logic 982, the transaction logic 984 and the gaming facilitator database 988.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A device for selling gaming products, comprising:
a first communication interface that communicates over a Near Field Communication (NFC) connection;
a second communication interface that communicates over a wireless network; and
a processor configured to
receive a game play request from a user,
detect, using the first communication interface, the device being tapped to an external NFC enabled device, and
upon detecting that the device has been tapped to the external NFC enabled device, send a gaming request associated with the game play request over the second communication interface.

2. The device of claim 1, further comprising:
a display that displays an option to complete a gaming transaction; and
a user interface that detects the user selecting the option, wherein
the processor is configured to detect the device being tapped to the external NFC enabled device after the user selects the option.

3. The device of claim 1, further comprising:
a memory, wherein
the processor is configured to store the game play request in the memory.

4. The device of claim 1, wherein the processor is configured to
obtain, using the first communication interface, identification information that identifies the external NFC enabled device, and
send the identification information over the second communication interface.

5. The device of claim 4, wherein
the identification information is location information that identifies a location of the external NFC enabled device, and
the processor is configured to send the location information over the second communication interface.

6. The device of claim 1, wherein the processor is configured to process payment associated with the game play request over the first communication network.

7. The device of claim 6, wherein the processor is configured to process the payment associated with the game play request over the first communication network in response to detecting that the device has been tapped to the external NFC enabled device a second time.

8. The device of claim 1, wherein the device is a smart phone.

9. The device of claim 1, wherein the second communication interface is a Wi-Fi interface.

10. The device of claim 1, wherein the second communication interface is a cellular interface.

11. A device for facilitating the sale of gaming products, comprising:
a first communication interface that communicates with a user device over a network;
a second communication interface that communicates with a gaming authority over a second network; and
a processor configured to
receive a game play request from the user device over the first communication interface, and
verify a location of the user device.

12. The device according to claim 11, wherein the processor is configured to
send a ticketing request corresponding with the game play request to the gaming authority over the second network, and
send a notification including a result of the ticketing request to the user device over the first network.

13. The device according to claim 11, wherein
the user device is configured to communicate over a Near Field Communication (NFC) connection,
the game play request includes information identifying an NFC enabled device that has been tapped by the user device, and
the processor is configured to verify the location of the user device based on the information identifying the NFC enabled device.

14. The device according to claim 11, further comprising
a third communication interface that communications with a Near Field Communication (NFC) enabled device, wherein
the user device is configured to communicate with the NFC enabled device over a NFC connection when tapped to the NFC enabled device,
the NFC enabled device sends information, to the device over the third communication interface, identifying the NFC enabled device upon being tapped by the user device, and
the processor is configured to verify the location of the user device based on the information identifying the NFC enabled device.

15. The device according to claim 11, wherein
the user device is configured to communicate over a proximity-based communication connection,
the game play request includes information identifying an proximity-based enabled device in proximity with the user device, and
the processor is configured to verify the location of the user device based on the information identifying the proximity-based enabled device.

16. The device according to claim 15, wherein the proximity-based communication connection comprises an audio-frequency communication connection.

17. The device according to claim 11, further comprising
a third communication interface that communications with an audio-frequency communication enabled device, wherein
the user device is configured to communicate with the audio-frequency communication enabled device over an audio-frequency communication connection when in proximity with the audio-frequency communication enabled device,
the audio-frequency communication enabled device sends information, to the device over the third communication interface, identifying the audio-frequency communication enabled device upon being in proximity with the user device, and
the processor is configured to verify the location of the user device based on the information identifying the audio-frequency communication enabled device.

18. A method for selling gaming product, comprising:
receiving, by a user device, a game play request from a user;
bringing the user device in proximity to a proximity-based communication enabled device;
sending a gaming request associated with the game play request to a gaming facilitator;
sending information identifying the proximity-based communication enabled device to the gaming facilitator;
verifying a location of the user device based on the information identifying the proximity-based communication enabled device;
obtaining payment authorization associated with the game play request;
sending a ticketing request corresponding with the gaming request to a gaming authority; and
sending a result of game play associated with the ticketing request to the user device.

19. The method of claim 18, wherein the proximity-based communication enabled device is an audio-frequency communication enabled device.

20. The method of claim 18, wherein the proximity-based communication enabled device is a Near Field Communication (NFC) enabled device.

21. The method of claim 20, further comprising:
tapping the user device to the NFC enabled device a second time to facilitate the obtaining of the payment authorization.

22. The method of claim 20, wherein the user device sends the information identifying the NFC enabled device to the gaming facilitator.

23. The method of claim 20, wherein the NFC enabled device sends the information identifying the NFC enabled device to the gaming facilitator in response to the user device being tapped to the NFC enabled device.

24. The method of claim 20, further comprising
maintaining a list of approved NFC enabled devices, wherein
the verifying the location of the user device includes verifying that the NFC enabled device that has been tapped by the user device is included in the list of approved NFC enabled devices.

25. The method of claim 20, wherein the user device is a smart phone.

26. A non-transitory computer readable medium encoded thereon with a program that when executed by a processor of a user device, causes the processor to perform a method comprising:
receiving a game play request from a user,
detecting, using a Near Field Communication (NFC) interface, the user device being tapped to an external NFC enabled device, and
sending, upon detecting that the user device has been tapped to the external NFC enabled device, a gaming request associated with the game play request over a wireless network to a gaming facilitator.
